(19) United States
(12) Patent Application Publication
(10) Pub. No.: US 2025/0184265 A1
(43) Pub. Date: Jun. 5, 2025

(54) NETWORK FUNCTION SOFTWARE UPGRADE

(71) Applicant: Manmeet Singh BHANGU

(72) Inventor: Manmeet Singh BHANGU

(21) Appl. No.: 18/294,442

(22) PCT Filed: Dec. 4, 2023
(86) PCT No.: PCT/US2023/082257

§ 371 Date: Feb. 1, 2024

(51) Int. Cl. H04L 45/00; H04L 41/00

(52) U.S. Cl. CPC H04L 45/563; H04L 41/20

(57) ABSTRACT

Provided are an apparatus, method, and device for upgrading a software of a network function. According to embodiments, the apparatus may be configured to: obtain upgrade data specifying an upgrade of a software of a network function; and upgrade the software of the network function using O2 Deployment Management Service based on the obtained upgrade data.

### CROSS REFERENCE TO RELATED APPLICATIONS

This application claims priority from Indian Provisional Patent Application No. 202341033472, filed with the Indian Patent Office on May 12, 2023 and entitled “NETWORK FUNCTION SOFTWARE UPGRADE”, the disclosure of which is incorporated herein by reference in its entirety.

### TECHNICAL FIELD

Systems, methods, and computer programs consistent with example embodiments of the present disclosure relate to a telecommunication network, and more specifically, relate to upgrading of network function software in a telecommunication network.

### BACKGROUND

A Network Function (NF) in a telecommunication network may refer to a component, a node, or the like that is configured to perform one or more functions within the network. In Kubernetes container platform, for example, an NF running on a Kubernetes cluster may be a containerized network function.

Such a containerized network function may be required to be upgraded after a certain period of time from deployment.

In the related art, a Service Management Orchestration (SMO) may be provided to manage an upgrade of a software of the containerized network function. However, the outdated software of the containerized network function is not secured while transferring Kubernetes resource objects from one unit to another unit, which causes security vulnerabilities, data loss and downtime.

### SUMMARY

Example embodiments of the present disclosure automatically upgrade a software of a network function using O2 Deployment Management Service. As such, example embodiments of the present disclosure provides a mean for upgrading a software of a running containerized workload on the Kubernetes cluster, with secured transfer of Kubernetes native resource objects from the SMO to an Application Programming Interface (API) server.

According to embodiments, an apparatus is provided. The apparatus may be configured to: obtain upgrade data, wherein the upgrade data may specify an upgrade of a software of a network function; and upgrade the software of the network function using O2 Deployment Management Service based on the obtained upgrade data.

According to embodiments, a method is provided. The method may include: obtaining upgrade data, wherein the upgrade data may specify an upgrade of a software of a network function; and upgrading the software of the network function using O2 Deployment Management Service based on the obtained upgrade data.

According to embodiments, a non-transitory computer-readable recording medium is provided. The non-transitory computer-readable recording medium may have recorded thereon instructions executable by an apparatus to cause the apparatus to perform a method including: obtaining upgrade data, wherein the upgrade data may specify an upgrade of a software of a network function; and upgrading the software of the network function using O2 Deployment Management Service based on the obtained upgrade data.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and wherein:

FIG. 1 illustrates a block diagram of an example system configuration for upgrading a software of a network function, according to one or more embodiments;

FIG. 2 illustrates a block diagram of example components in a SU system, according to one or more embodiments;

FIG. 3 illustrates an example network configuration of a container-based cluster network, according to one or more embodiments;

FIG. 4 illustrates a block diagram of example components of a node, according to one or more embodiments;

FIG. 5 illustrates a flow diagram of an example method for upgrading a software of a network function, according to one or more embodiments;

FIG. 6 illustrates a flow diagram of an example method for obtaining upgrade data, according to one or more embodiments;

FIG. 7 illustrates a flow diagram of an example method for upgrading the software of the network function using O2 Deployment Management Service, according to one or more embodiments;

FIGS. 8A to 8B illustrate an example flow of upgrading the software of the network function, according to one or more embodiments; and

FIG. 9 illustrates a diagram of an example environment in which systems and/or methods, described herein, may be implemented.

### DETAILED DESCRIPTION

The following detailed description of example embodiments refers to the accompanying drawings. The same reference numbers in different drawings may identify the same or similar elements.

The foregoing disclosure provides illustration and description but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are disclosed in the specification, these combinations are not intended to limit the disclosure of possible implementations. In fact, many of these features may be combined in ways not specifically disclosed in the specification.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Apparatuses, methods, devices, and the like, provided in the example embodiments of the present disclosure automatically upgrade a software of a network function using O2 Deployment Management Service.

As mentioned previously, a containerized network function running on a Kubernetes cluster may be required to be upgraded after a certain period of time after deployment.

In the related art, a Service Management Orchestration (SMO) may be provided to manage an upgrade of a software of the containerized network function. However, the outdated software of the containerized network function may not be secured while transferring Kubernetes resource objects from one unit to another unit, which causes security vulnerabilities, data loss and downtime.

According to embodiments, the system may obtain upgrade data specifying an upgrade of a software of a network function, and then upgrade the software of the network function using O2 Deployment Management Service based on the obtained upgrade data.

Ultimately, example embodiments of the present disclosure automatically upgrade a software of a network function using O2 Deployment Management Service, which provides a mean for upgrading a software of a running containerized workload on the Kubernetes cluster, with secured transfer of Kubernetes native resource objects from the SMO to an Application Programming Interface (API) server.

It is contemplated that features, advantages, and significances of example embodiments described hereinabove are merely a portion of the present disclosure, and are not intended to be exhaustive or to limit the scope of the present disclosure.

Further descriptions of the features, components, configuration, operations, and implementations of the threshold tuning system of the present disclosure, according to one or more embodiments, are provided in the following.

### Example System Architecture

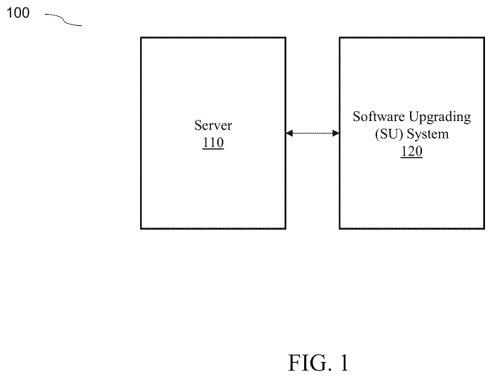

FIG. 1 illustrates a block diagram of an example system configuration 100 for upgrading a software of a network function, according to one or more embodiments. As illustrated in FIG. 1, system configuration 100 may include a server 110 and Software Upgrading (SU) system 120.

Server 110 may include a server configured to validate, configure, and deploy network functions within a network. According to embodiments, the server 110 may refer to an Application Programming Interface (API) server. For example, the server 110 may refer to a Kubernetes API server which is configured to validate and configure data for API objects within a Kubernetes container platform. Server 110 may be communicatively coupled to the SU system 120.

SU system 120 may include a system, a platform, a module, an apparatus, or the like, which may be configured to perform one or more operations or actions for upgrading a software of a network function in a network. According to embodiments, the SU system 120 may include a Service Management Orchestration (SMO) having a Network Function Orchestrator (NFO).

According to embodiments, the network function may include a cloudified network function. According to embodiments, the cloudified network function may refer to a Radio Access Network (RAN) Function software, which may be deployable in an O-Cloud via one or more network function deployments (NF Deployment). It may be understood that the network function deployment may refer to a software deployment on O-Cloud resources that realizes, all or part of, the cloudified network function. According to embodiments, the network function may include the network function deployment itself.

According to embodiments, the SU system 120 (SMO) may be involved in the coordination and automation of various tasks and processes involved in upgrading the software running on network devices, such as routers, switches, firewalls, and other network functions. According to embodiments, the NFO may be simulated to draw out requirements for an SMO implementation; where tools and microservices are developed as part of this use case which can be integrated to any SMO environment.

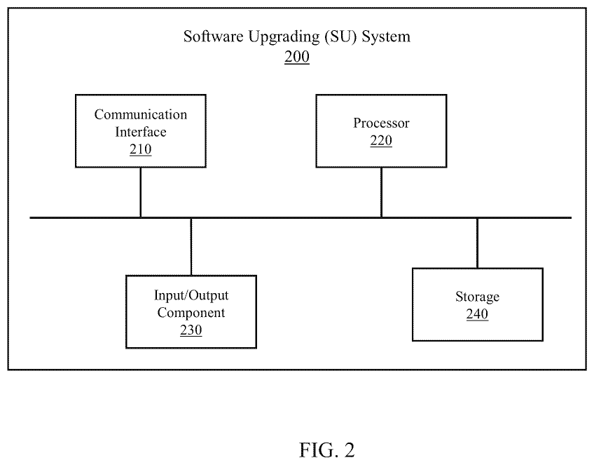

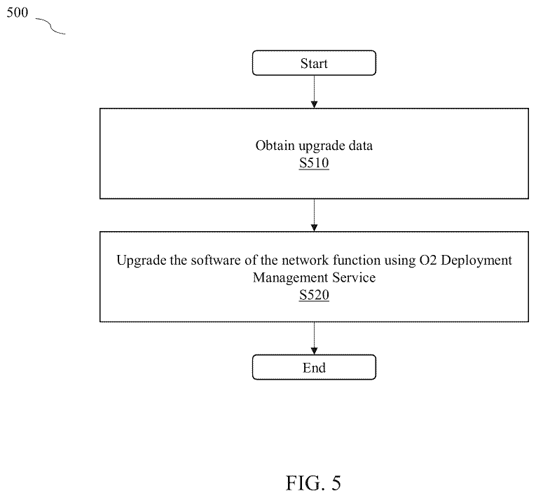

Example operations performable by the SU system 120 for upgrading a software of a network function are described below with reference to FIG. 5 to FIG. 8. Further, several example components which may be included in the SU system 120, according to one or more embodiments, are described below with reference to FIG. 2.

FIG. 2 illustrates a block diagram of example components in a SU system 200, according to one or more embodiments. The SU system 200 may correspond to the SU system 120 in FIG. 1, thus the features associated with the SU system 120 and the SU system 200 may be similarly applicable to each other, unless being explicitly described otherwise.

As illustrated in FIG. 2, the SU system 200 may include at least one communication interface 210, at least one processor 220, at least one input/output component 230, and at least one storage 240, although it can be understood that the SU system 200 may include more or less components than as illustrated in FIG. 2, and/or may be arranged in a manner different from as illustrated in FIG. 2, without departing from the scope of the present disclosure.

The communication interface 210 may include at least one transceiver-like component (e.g., a transceiver, a separate receiver and transmitter, a bus, etc.) that enables the components of the SU system 200 to communicate with each other and/or to communicate with one or more components external to the SU system 200, such as via a wired connection, a wireless connection, or a combination of wired and wireless connections.

For instance, the communication interface 210 may couple the processor 220 to the storage 240 to thereby enable them to communicate and to interoperate with each other in performing one or more operations. As another example, communication interface 210 may couple the SU system 200 (or one or more components included therein) to the server 110, so as to enable them to communicate and to interoperate with each other.

According to one or more embodiments, the communication interface 210 may include one or more application programming interfaces (APIs) which allows the SU system 200 (or one or more components included therein) to communicate with one or more software applications.

The input/output component 230 may include at least one component that permits the SU system 200 to receive information and/or to provide output information. It can be understood that, in some embodiments, the input/output component 230 may include at least one input component (e.g., a touch screen display, a button, a switch, a microphone, a sensor, etc.) and at least one output component (e.g., a display, a speaker, one or more light-emitting diodes (LEDs), etc.), each of which may be separated from each other.

The storage 240 may include one or more storage mediums suitable for storing data, information, and/or computer-executable instructions therein. According to embodiments, the storage 240 may include at least one memory storage, such as a random access memory (RAM), a read only memory (ROM), and/or another type of dynamic or static storage device (e.g., a flash memory, a magnetic memory, and/or an optical memory) that stores information and/or instructions for use by the processor 220. Additionally or alternatively, the storage 240 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

According to embodiments, the storage 240 may be configured to store information, such as raw data, metadata, or the like. Additionally or alternatively, the storage 240 may be configured to store one or more information associated with one or more operations performed by the processor 220. For instance, the storage 240 may store information defining the historical operation(s) performed by the processor 220 to upgrade a software of a network function, one or more results of operations performed by the processor 220, or the like. Further, the storage 240 may store data or information required in upgrading the software of the network function.

In some implementations, the storage 240 may include a plurality of storage mediums, and the storage 240 may be configured to store a duplicate or a copy of at least a portion of the information in the plurality of storage mediums, for providing redundancy and for backing-up the information or the associated data. Furthermore, the storage 240 may also store computer-readable or computer-executable instructions which, when being executed by one or more processors (e.g., processor 220), causes the one or more processors to perform one or more actions/operations described herein

The processor 220 may include at least one processor capable of being programmed or being configured to perform a function(s) or an operation(s) described herein. For instance, the processor 220 may be configured to execute computer-executable instructions stored in at least one storage medium or a memory storage (e.g., storage 240, etc.) to thereby perform one or more actions or one or more operations described herein.

According to embodiments, the processor 220 may be configured to receive (e.g., via the communication interface 210, via the input/output component 230, etc.) one or more signals and/or one or more user inputs defining one or more instructions for performing one or more operations. Further, the processor 220 may be implemented in hardware, firmware, or a combination of hardware and software. For instance, processor 220 may include at least one of a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), and/or another type of processing or computing component.

According to embodiments, the processor 220 may be configured to collect, to extract, and/or to receive one or more information (in the form of signal or data, etc.), and to process the received one or more information to thereby upgrade the software of the network function.

Descriptions of several example operations which may be performed by the processor 220 are provided below with reference to FIG. 5 to FIG. 8.

According to embodiments, the system configuration 100 may be deployed in a container-based cluster network.

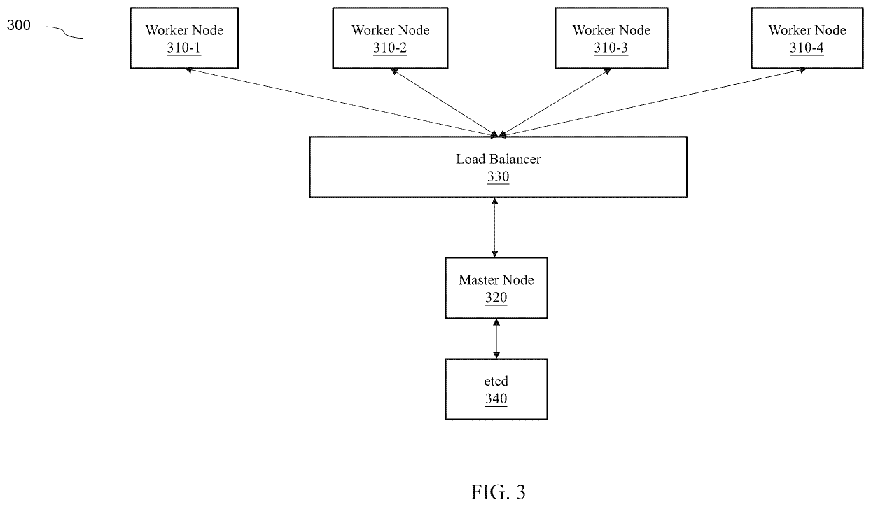

FIG. 3 illustrates an example network configuration of a container-based cluster network 300, according to one or more embodiments. In the container-based cluster network 300, a master node and a plurality of worker nodes may interoperate to manage and run containerized applications. The cluster network 300 may include, for example, a Kubernetes (K8s) cluster network.

As illustrated in FIG. 3, the network 300 may include a plurality of worker nodes 310-1 to 310-4, a master node 320 a load balancer 330, and an etcd 340. It can be understood that, in practice, the configuration of network 300 may be different from as illustrated (e.g., more or less worker nodes and/or master nodes may be included, etc.).

Each of the plurality of worker nodes 310-1 to 310-4 may include a component, such as a server, that hosts, runs, and manages one or more containers of one or more applications. The plurality of worker nodes 310-1 to 310-4 may be managed by the master node 320. For instance, the master node 320 may communicate with the worker nodes 310-1 to 310-4 to assign or schedule workloads to the worker nodes 310-1 to 310-4 and to monitor the status thereof.

The master node 320 may include a server that comprises control plane components, such as an application programming interface (API) server which provides the interface for interacting with the cluster (e.g., communicate with the plurality of worker nodes 310-1 to 310-4, communicate with the load balancer 330, communicate with other master nodes, etc.), a scheduler which assigns and schedules workloads to the worker nodes 310-1 to 310-4, and a controller manager which performs appropriate action(s) to control the cluster to a desired state.

The load balancer 330 may interface between the worker nodes 310-1 to 310-4 and the master node 320, and may be configured to distribute traffic and load across the worker nodes 310-1 to 310-4 and the master node 320. For instance, the load balancer may appropriately distribute the traffic and load (e.g., received from the master node, received from an external client, etc.) across available worker nodes to prevent any one of the worker nodes from becoming overloaded.

The master node 320 has an etcd 340 associated therewith. The etcd 340 may include a server or a database configured to store configuration data of the cluster, such as configuration of components in the network, metadata of the running containers, logs of changes, and the like. In some implementations, the API server in the master node interacts with the respective etcd to read and/or write the configuration data. Further, the etcd may be included in the respective master node as a stack, or may be external to the respective master node.

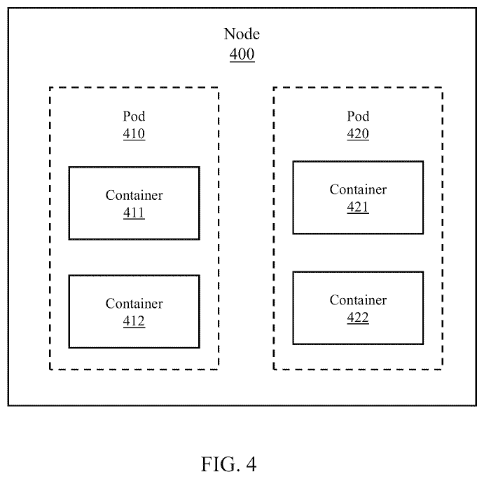

FIG. 4 illustrates a block diagram of example components of a node 400, according to one or more embodiments.

In this example embodiment, the network function of the network may be defined in software form via, for example, containerization (or any other suitable technology). Accordingly, the containerized network function may be deployed, in the form of containers, in the node 400, and the functionalities of the network function may be performed or be achieved via execution or orchestration of the containers associated with the network function.

As illustrated in FIG. 4, the node 400 may include a plurality of containers 411-412 and 421-422. The containerized network function may be disaggregated or scattered among the plurality of containers 411-412 and/or 421-422. According to embodiments, the node 400 may include a Kubernetes (K8s) node, and the containers of the network function may be grouped or aggregated in a respective pod (e.g., containers associated with a first function of the network function are included in a first pod 410, containers associated with a second function of the network function are included in a second pod 420, etc.). The plurality of pods in the node 400 may share the same networking resources (e.g., CPU, memory, etc.) provided by the node 400.

In this way, the network function may be managed by adjusting the pods and/or containers associated with the network function. For instance, the network function may be scaled up by increasing the number of containers and/or pods associated therewith, may be scaled down by decreasing the number of containers and/or pods associated therewith, or the like.

In some implementations, the node 400 may refer to a component, a module, or a physical hardware (e.g., a server, etc.) including suitable components or resources (e.g., CPU, memory, storage, bandwidth, etc.) for hosting and executing the containerized network function. Alternatively, the node 400 may refer to a collection of resources (e.g., CPU, memory, etc.) for hosting and executing the containerized network function, and may be presented in the form of virtual machines.

It can be understood that the configuration illustrated in FIG. 4 is simplified for descriptive purpose, and is not intended to limit the scope of the present disclosure. Specifically, in practice, the node 400 may include any suitable components for hosting and executing a plurality of pods, while the number of pods may be greater than two and the number of containers included in each pod may be greater than two, without departing from the scope of the present disclosure. Further, it can be understood that the containerized network function may be hosted or deployed in a plurality of nodes, in a similar manner as described above. Furthermore, it can be understood that multiple nodes may include the same containers (or pods) in order to provide network redundancy to thereby improve the network availability.

### Example Operations for Upgrading a Software of a Network Function in the Present Disclosure

In the following, several example operations performable by the SU system of the present disclosure are described with reference to FIG. 5 to FIG. 8.

FIG. 5 illustrates a flow diagram of an example method 500 for upgrading a software of a network function, according to one or more embodiments. One or more operations in method 500 may be performed by at least one processor (e.g., processor 220) of the SU system.

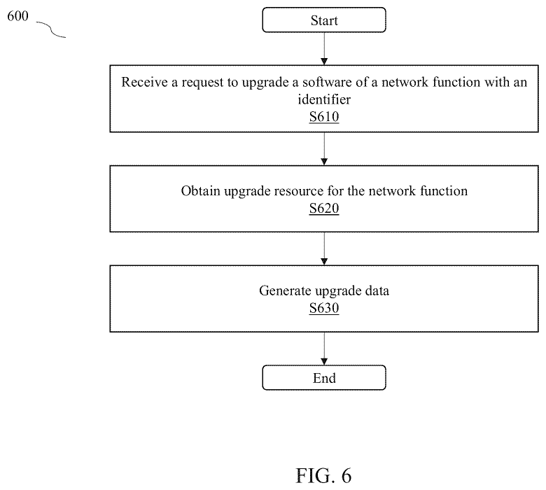

As illustrated in FIG. 5, at operation S510, the at least one processor may be configured to obtain upgrade data. According to embodiments, the upgrade data may be obtained based on information provided by a user. According to embodiments, the upgrade data may specify an upgrade of a software of a network function. According to embodiments, the upgrade data may include resource manifests. For example, the upgrade data may include parameterized Kubernetes native resource manifests. According to embodiments, the parameterized Kubernetes native resource manifests may be used by the server in order to generate an upgraded instance of the network function having upgraded software. According to embodiments, the network function may include a containerized network function that is running on a Kubernetes cluster. Examples of operations for obtaining upgrade data are described below with reference to FIG. 6. The method then proceeds to operation S520.

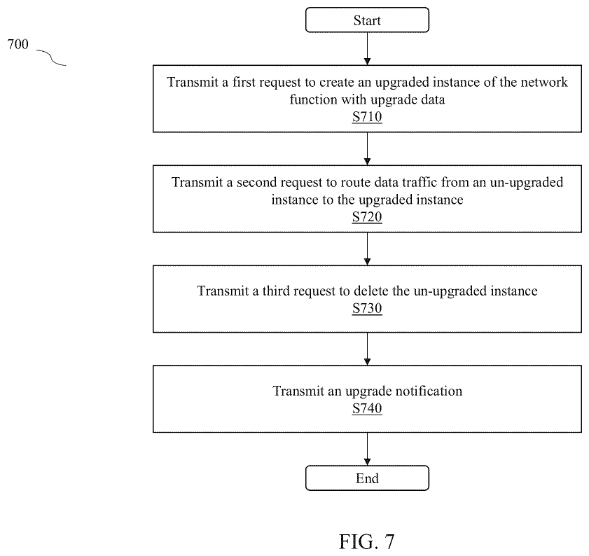

At operation S520, the at least one processor may be configured to upgrade the software of the network function using O2 Deployment Management Service. According to embodiments, the software of the network function may be upgraded based on the obtained upgrade data. Examples of operations for upgrading the software of the network function using O2 Deployment Management Service are described below with reference to FIG. 7.

Upon performing operation S520, the method 500 may be ended or be terminated. Alternatively, method 500 may return to operation S510, such that the at least one processor may be configured to repeatedly perform, for at least a predetermined amount of time, the obtaining the upgrade data (at operation S510) and the upgrading the software of the network function (at operation S520). For instance, the at least one processor may continuously (or periodically) receive instructions to upgrade the software of the network function from the user, and then restart the obtaining the upgrade data (at operation S510) and the upgrading the software of the network function (at operation S520).

To this end, efficient and reliable software upgrades of network functions, reduction in risk of errors, downtime, and service disruptions may be achieved. Further, by automating routine tasks and coordinating different teams involved in the upgrade process, the SU system may be able to improve overall quality of service delivery and customer satisfaction.

In particular, the system of the present disclosure provides a means for upgrading a software of a running containerized workload on the Kubernetes cluster, with secured transfer of Kubernetes native resource objects from the SMO to an Application Programming Interface (API) server.

### Example Operations for Obtaining Upgrade Data in the Present Disclosure

FIG. 6 illustrates a flow diagram of an example method 600 for obtaining upgrade data, according to one or more embodiments. One or more operations of method 600 may be part of operation S510 in method 500, and may be performed by at least one processor (e.g., processor 220) of the SU system.

As illustrated in FIG. 6, at operation S610, the at least one processor may be configured to receive a request to upgrade a software of a network function with an identifier. According to embodiments, the request and the identifier may be received from a user. According to embodiments, the network function may include a containerized network function. For example, the network function may include a containerized network function that is running on a Kubernetes cluster. According to embodiments, the identifier may include an identifier for the network function that is to be upgraded. The method then proceeds to operation S620.

At operation S620, the at least one processor may be configured to obtain upgrade resource for the network function. According to embodiments, the upgrade resource may refer to resources to be updated (upgraded) for the network function. For example, the upgrade resource may include artifacts in Kubernetes container platform, which represent resources that is updated (upgraded) as part of the deployment. An example of artifacts may include workload descriptors, such as Application Service Descriptor (ASD) and HelmCharts, obtained from a repository. According to embodiments, the upgrade resource may be obtained based on the identifier.

According to embodiments, a selection of a cluster may be received with the request from the user. It may be understood that the cluster may refer to, for example, Kubernetes cluster in which an upgraded network function is located. According to embodiments, if a selection of a cluster is not received (i.e., if a cluster is not selected by the user), the at least one processor may be further configured to perform homing by matching the requirements of the containerized network function with the resources available on the Kubernetes cluster and adds information about the network function being deployed in an SMO inventory. The method then proceeds to operation S630.

At operation S630, the at least one processor may be configured to generate upgrade data. According to embodiments, the upgrade data may be generated based on the obtained upgrade resource. According to embodiments, the upgrade data may specify an upgrade of a software of a network function. According to embodiments, the upgrade data may include resource manifests, such as parameterized Kubernetes native resource manifests, which may be used by the server in order to generate an upgraded instance of the network function having upgraded software. For example, the parameterized Kubernetes native resource manifests may be generated from the obtained artifacts using the SMO internal workload deployment toolchain (e.g., Helm Client).

### Example Operations for Upgrading a Software of a Network Function Using O2 Deployment Management Service in the Present Disclosure

FIG. 7 illustrates a flow diagram of an example method 700 for upgrading the software of the network function using O2 Deployment Management Service, according to one or more embodiments. One or more operations of method 700 may be part of operation S520 in method 500, and may be performed by at least one processor (e.g., processor 220) of the SU system. As illustrated below, the upgrade of the software utilizes a build-and-replace approach, where an old network function is not deleted until the software upgrade of the network function is done without disrupting existing data traffic.

As illustrated in FIG. 7, at operation S710, the at least one processor may be configured to transmit a first request to create an upgraded instance of the network function with upgrade data. According to embodiments, the upgrade data may refer to the upgrade data generated during operation S630 in method 600. According to embodiments, the upgraded instance of the network function may refer to an instance of the network function having an upgraded software.

According to embodiments, the first request and the upgrade data may be transmitted using O2 Deployment Management Service (O2dms) with the server as a termination point for the O2dms in a cluster. Through the use of O2dms, secured transfer of Kubernetes native resource objects from the SU system to the server in a target Kubernetes cluster may be achieved.

According to embodiments, the first request and the upgrade data may be transmitted to a server, such as a Kubernetes API server. According to embodiments, the server may be located in the cluster selected by the user. For example, the SMO may be configured to transmit the first request and the parameterized Kubernetes native resource manifests to the Kubernetes API server in the selected Kubernetes cluster using the O2dms interface, by making a Hypertext Transfer Protocol (HTTP) POST call to a respective Uniform Resource Locator (URL) with the Kubernetes native resource manifest as a payload.

According to embodiments, in response to receiving the first request and the upgrade data, the server may be configured to authenticate the first request and validate the upgrade data. In response to a successful authentication and validation of the first request and the upgrade data, the server may be configured to create (deploy) the upgraded instance of the network function based on the upgrade data. For example, the upgraded instance of the network function may be deployed (created) as a new Kubernetes deployment object with a new label. According to embodiments, the upgraded instance may be deployed without being exposed to data traffic.

It may be understood that, in response to the creation of the upgraded instance of the network function, Kubernetes worker nodes may be notified that the deployed containerized workload needs to be instantiated. Subsequently, the Kubernetes worker node may be configured for a workload execution that fetches container images from an image registry specified in the resource manifests files and starts its execution by provisioning the required number of resources.

According to embodiments, the server may be configured to transmit a notification to the SU system, acknowledging the creation of the upgraded instance of the network function in the cluster selected by the user. The method then proceeds to operation S720.

At operation S720, the at least one processor may be configured to transmit a second request to route data traffic from an un-upgraded instance of the network function to the upgraded instance of the network function. According to embodiments, the un-upgraded instance of the network function may refer to an instance of the network function having un-upgraded software. According to embodiments, the second request to route data traffic may be transmitted to the server. According to embodiments, in response to receiving the request, the server may be configured to configure and/or create a load balancer to route data traffic from the un-upgraded instance of the network function to the upgraded instance of the network function.

Alternatively, the at least one processor may be configured to transmit a second request to create a load balancer to the server; where, once the load balancer is created by the server, the at least one processor may be configured to configure the load balancer to route data traffic from the un-upgraded instance of the network function to the upgraded instance of the network function.

As such, the data traffic may gradually shift from an old instance (un-upgraded instance of the network function) to the new instance (upgraded instance of the network function) until all data traffic is successfully routed to the new instance.

According to embodiments, the at least one processor may be configured to first check the upgraded instance of the network function for readiness, and may transmit the second request to route data traffic once the upgraded instance of the network function is ready for data traffic. According to embodiments, the at least one processor may be further configured to monitor the data traffic shift from the un-upgraded instance of the network function to the upgraded instance of the network function, and to verify whether the upgraded instance of the network function is handling the data traffic correctly.

According to embodiments, the second request may be transmitted using O2 Deployment Management Service (O2dms). The method then proceeds to operation S730.

At operation S730, the at least one processor may be configured to transmit a third request to delete the un-upgraded instance of the network function. According to embodiments, the third request to delete the un-upgraded instance may be transmitted to the server. According to embodiments, in response to receiving the request, the server may be configured to authenticate the request. In response to a successful authentication of the request, the server may be configured to delete the un-upgraded instance of the network function.

It may be understood that, in response to the deletion of the un-upgraded instance of the network function, Kubernetes worker nodes may be notified to release any resources held by the un-upgraded instance of the network function. It may also be understood that the Kubernetes worker node may automatically stop the execution of workloads for which the resource objects no longer exist in the Kubernetes cluster and then release the resources.

According to embodiments, the server may be configured to transmit a notification to the SU system, acknowledging the deletion of the un-upgraded instance of the network function.

According to embodiments, the third request may be transmitted using O2 Deployment Management Service (O2dms). The method then proceeds to operation S740.

At operation S740, the at least one processor may be configured to transmit an upgrade notification. According to embodiments, the upgrade notification may be transmitted to the user. According to embodiments, the upgrade notification may be configured to notify the user regarding an outcome of the request to upgrade the software of the network function (i.e., the request received during operation S610 in method 600). For example, the upgrade notification may notify the user that the software of the network function is successfully upgraded.

Accordingly, the present disclosure describes the use case for SMO managed software upgrade of an NF Deployment (i.e., network function) and its realization based on O2dms K8s API profile.

### Build-and-Replace Software Upgrade

The present disclosure illustrates a build-and-replace NF Deployment upgrade approach in which a NF Deployment using old software version is replaced by a new and independently deployed instance using newer software version. This approach utilizes a graceful or soft upgrade where the old NF Deployment is not removed from a K8s cluster until such removal can be done without disrupting existing traffic that the NF Deployment supports.

Upon receiving a request to upgrade software of a particular NF Deployment, the SMO instantiates a new NF Deployment. The new instance is created independently and uses newer software version of the NF Deployment. If an exception occurs during the instantiation step that causes the new NF Deployment not to be created successfully, the operation is rolled back and further actions are aborted i.e., the new NF Deployment instance is removed, and the old NF Deployment continues to provide service as before.

After instantiation of the new NF Deployment is successful, the SMO may trigger further actions e.g., 01 configuration of parts of the NF (cloudified network function) related to the NF Deployment. Once the new NF Deployment is up and running, the old NF Deployment is terminated.

### Example Flow of Upgrading a Software of a Network Function in the Present Disclosure

FIGS. SA to SB illustrate an example flow of upgrading the software of the network function, according to one or more embodiments.

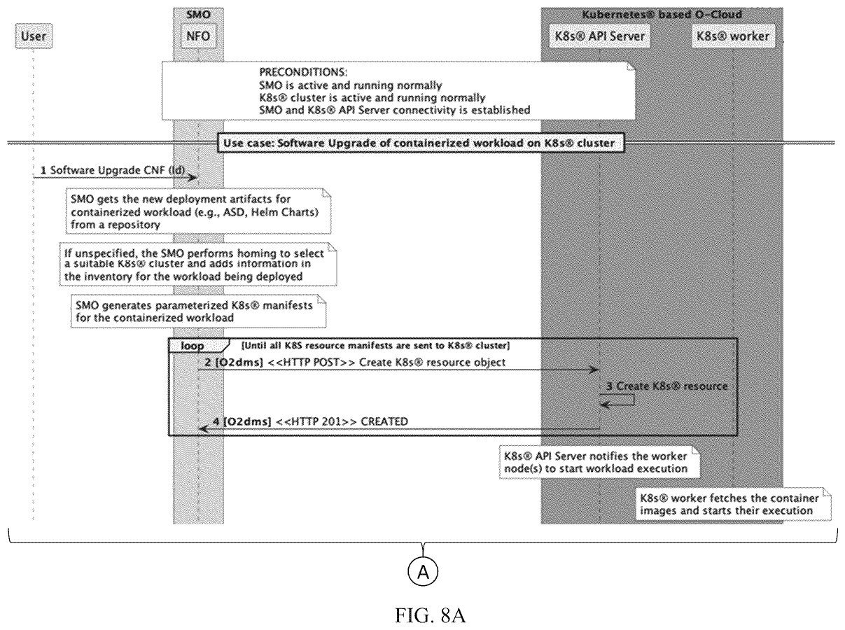

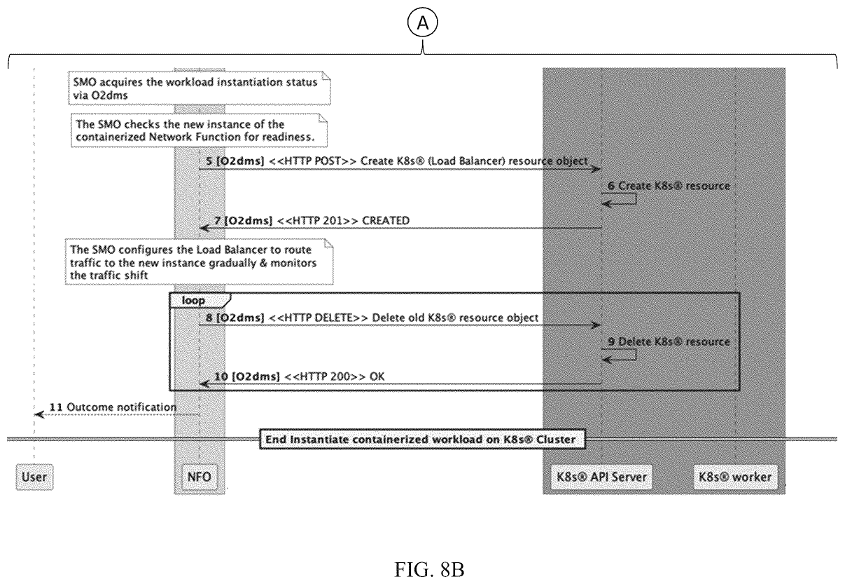

As illustrated in FIGS. 8A to 8B, it is assumed that the SMO and the selected Kubernetes (K8s) cluster are active and running normally; where the containerized network function that is to be upgraded is running on the selected Kubernetes cluster. Further, it is assumed that the SMO and the Kubernetes (K8s) API server connectivity is established, where the Kubernetes (K8s) API server is accessible via the O2dms interface.

At operation 1, the user decides to upgrade the software of the running containerized network function on the Kubernetes cluster, and transmits a request to upgrade the software on the running containerized network function to the SMO with an identifier for that network function. Subsequently, the SMO obtains the deployment artifacts, performs homing (if necessary), and generates a parameterized Kubernetes native resource manifests.

At operation 2, the SMO sends the Kubernetes native resource manifests to the Kubernetes API server in the selected Kubernetes cluster using the O2dms interface by making a Hypertext Transfer Protocol (HTTP) POST call to a respective Uniform Resource Locator (URL) with the Kubernetes resource manifest as a payload.

At operation 3, the Kubernetes API server authenticates the request, validates the resource manifests, and creates the respective resource objects in the Kubernetes cluster.

At operation 4, the Kubernetes API server responds to the SMO by acknowledging the creation of the requested resource objects in the Kubernetes cluster. Here, the Kubernetes API server notifies Kubernetes worker nodes that the deployed containerized workload needs to be instantiated, and the Kubernetes worker node starts a workload execution that fetches container images from an image registry specified in the resource manifests files and starts its execution by provisioning required number of resources.

After operation 4, the SMO acquires the workload instantiation status via O2dms, and checks the new instance of the containerized network function for readiness.

At operation 5, the SMO transmits a request to create a load balancer to the Kubernetes API server.

At operation 6, the Kubernetes API server authenticates the request, and creates the load balancer.

At operation 7, the Kubernetes API server responds to the SMO by acknowledging the creation of the load balancer. Here, the SMO configures the load balancer to route the traffic to the new instance gradually, as well as monitors the traffic shift.

At operation 8, the SMO transmits a request to delete the old instance of the containerized network function to the Kubernetes API server.

At operation 9, the Kubernetes API server authenticates the request, and deletes the old instance of the containerized network function.

At operation 10, the Kubernetes API server responds to the SMO by acknowledging the deletion of the old instance of the containerized network function.

At operation 11, the SMO notifies the user about an outcome of a software upgrade request.

The software upgrade of the network function use case ends when the software upgrade of the network function is completed on the running containerized network function.

Subsequently, the software upgrade of the network function is complete and traffic is moved from the old instance to the new instance (with upgraded software) and the old instance is deleted.

### Contribution

Clause 3.2.4 of O-RAN.WG6.ORCH-USE-CASES [2] describes SMO-managed upgrade to the software of the Network Function. The software upgrade of NF use case requires the SMO to upgrade the software of a running containerized workload on a Kubernetes cluster. In this O2dms profile, the upgrade of the software is realized by secured transfer of the Kubernetes native resource objects from the SMO to the API Server function in the target Kubernetes cluster.

This use case illustrates the build-and-replace NF software upgrade approach. This approach utilizes a graceful or soft upgrade where the old NF is not deleted until this can be done without disrupting existing traffic it supports.

FIG. 8A and FIG. 8B exemplifies the software upgrade flow in O2dms Kubernetes profile.

TABLE 1
Software Upgrade of Network Function

| Use Case | |
|---|---|
| Stage | Evolution/Specification |
| Use Case | Software Upgrade of containerized workload on a selected Kubernetes |
| | cluster |
| Goal | The goal of this use case is to upgrade the software of the running |
| | containerized Network Function on the Kubernetes cluster. |
| Actors and | SMO: The SMO initiates the software upgrade process |
| roles | Kubernetes API Server: O2dms termination point in Kubernetes |
| | cluster |
| Preconditions | SMO is active and running normally |
| | Selected Kubernetes cluster is running normally |
| | Kubernetes API server is accessible via O2dms interface |
| | Running containerized Network Function is up and running on the |
| | selected Kubernetes cluster |
| Begins when | The SMO decides to upgrade the software of a running containerized |
| | Network Function on the Kubernetes cluster |
| Step 1 (M) | A request to upgrade the software on a running containerized Network |
| | Function is received by the SMO with an identifier for that Network |
| | Function. |
| | Note: The identifier provided is used by the SMO to get related |
| | artifacts for that workload. Examples of such artifacts includes |
| | workload descriptors (e.g., ASD and HelmCharts). |
| | Note: If the cluster is not user selected, the SMO performs homing |
| | by matching the requirements of the containerized workload with the |
| | resources available on the Kubernetes cluster. The SMO adds |
| | information about the workload being deployed in the SMO |
| | inventory. |
| | Note: The SMO generates parameterized Kubernetes native resource |
| | manifests from the workload artifacts using SMO internal workload |
| | deployment toolchain (e.g., Helm Client). |
| Step 2 (M) | The SMO sends the Kubernetes native resource manifests to the API Server |
| | function in the chosen Kubernetes cluster using O2dms interface by making |
| | an HTTP POST call to the respective resource URL with the Kubernetes |
| | resource manifest as payload. |
| | Note: The new instance is deployed as a new Kubernetes |
| | Deployment object with a new label. |
| | Note: The new instance is created without exposing it to traffic. |
| Step 3 (M) | The API Server function authenticates the request and validates the resource |
| | manifests and creates the respective resource objects in Kubernetes cluster |
| | Note: The creation of a Kubernetes resource object results in an |
| | internal notification to the worker nodes that the deployed |
| | containerized workload needs to be instantiated |
| | Note: A worker node responsible for the workload execution fetches |
| | the container images from the image registry specified in the resource |
| | manifests files and starts it execution by provisioning the required |
| | number of resources. |
| Step 4 (M) | The API Server responds to the SMO by acknowledging the creation of the |
| | requested resource objects in the Kubernetes cluster. |
| | Note: The SMO checks the new instance of the containerized |
| | Network Function for readiness. If the new instance is not ready, the |
| | SMO waits until it is ready |
| Step 5 (M) | The SMO configures the Load Balancer to route traffic to the new instance |
| | gradually. |
| | Note: The traffic is gradually shifted from the old instance to the new |
| | instance until all traffic is successfully routed to the new instance. |
| | Note: The SMO monitors the traffic shift and verifies that the new |
| | instance is handling traffic correctly. |
| Step 6 (M) | The SMO deletes the old instance of the containerized Network Function. |
| | Note: The old instance is deleted only after all traffic has been |
| | successfully routed to the new instance. |
| Step 7 (M) | The API Server function authenticates the request and deletes the requested |
| | resource objects from the Kubernetes cluster |
| | Note: The deletion of a Kubernetes resource object results in an |
| | internal notification to the worker nodes to release any resources held |
| | by that workload. |
| | Note: The Kubernetes worker nodes stop the execution of workloads |
| | automatically for which the resource objects no longer exist in the |
| | Kubernetes cluster and release the resources. |
| Step 8 (M) | The API Server responds to the SMO by acknowledging the deletion of the |
| | requested resource objects in the Kubernetes cluster. |
| Step 9 (O) | The SMO notifies the user about the outcome of software upgrade request |
| Ends when | This use case ends when the software upgrade is completed on the running |
| | containerized |
| Post Condition | The software upgrade of the NF is complete and traffic is moved from old |
| | NF instance to new NF instance (with updated software) and the old NF |
| | instance has been deleted |

### Example Implementation Environment

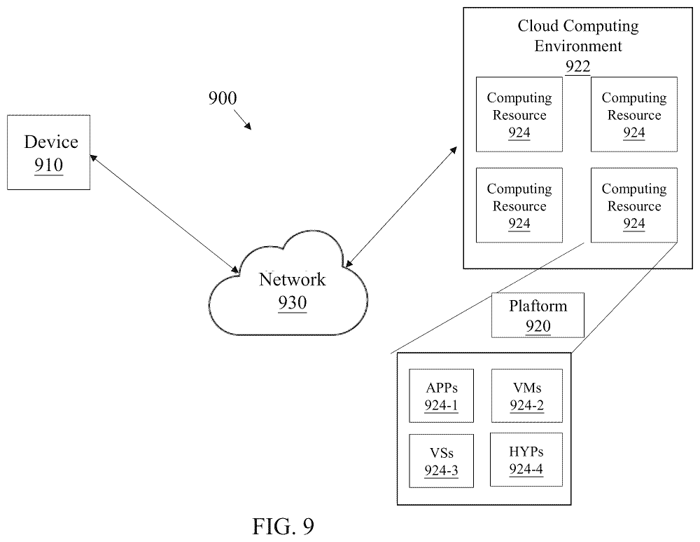

FIG. 9 illustrates a diagram of an example environment 900 in which systems and/or methods, described herein, may be implemented. As shown in FIG. 9, environment 900 may include a device 910, a platform 920, and a network 930. Devices of environment 900 may interconnect via wired connections, wireless connections, or a combination of wired and wireless connections. In some embodiments, any of the functions and operations described with reference to FIG. 1 to FIG. 8 above may be performed by any combination of elements illustrated in FIG. 9.

According to embodiments, the SU system described herein may be stored, hosted, or deployed in the cloud computing platform 920. In this regard, device 910 may include a device, system, equipment, or the like, utilized by the user (e.g., user of a marketing team, user of a network planning team, etc.) to access the SU system. In that case, device 910 may include one or more devices capable of receiving, generating, storing, processing, and/or providing information associated with platform 920.

Platform 920 includes one or more devices capable of receiving, generating, storing, processing, and/or providing information. In some implementations, platform 920 may include a cloud server or a group of cloud servers. In some implementations, platform 920 may be designed to be modular such that certain software components may be swapped in or out depending on a particular need. As such, platform 920 may be easily and/or quickly reconfigured for different uses.

In some implementations, as shown, platform 920 may be hosted in cloud computing environment 922. Notably, while implementations described herein describe platform 920 as being hosted in cloud computing environment 922, in some implementations, platform 920 may not be cloud-based (i.e., may be implemented outside of a cloud computing environment) or may be partially cloud-based.

Cloud computing environment 922 includes an environment that hosts platform 920. Cloud computing environment 922 may provide computation, software, data access, storage, etc. services that do not require end-user (e.g., user device 910) knowledge of a physical location and configuration of system(s) and/or device(s) that hosts platform 920. As shown, cloud computing environment 922 may include a group of computing resources 924 (referred to collectively as “computing resources 924” and individually as “computing resource 924”).

Computing resource 924 includes one or more personal computers, a cluster of computing devices, workstation computers, server devices, or other types of computation and/or communication devices. In some implementations, computing resource 924 may host platform 920. The cloud resources may include compute instances executing in computing resource 924, storage devices provided in computing resource 924, data transfer devices provided by computing resource 924, etc. In some implementations, computing resource 924 may communicate with other computing resources 924 via wired connections, wireless connections, or a combination of wired and wireless connections.

As further shown in FIG. 9, computing resource 924 includes a group of cloud resources, such as one or more applications (“APPs”) 924-1, one or more virtual machines (“VMs”) 924-2, virtualized storage (“VSs”) 924-3, one or more hypervisors (“HYPs”) 924-4, or the like. While the current example embodiment is with reference to virtualized network functions, it is understood that one or more other embodiments are not limited thereto, and may be implemented in at least one of containers, cloud-native services, one or more container platforms, etc. For example, in one or more other example embodiments, any of the above-described components may be a software-based component deployed or hosted in, for example, a server cluster such as a hybrid cloud server, data center servers, and the like. The software-based component may be containerized and may be deployed and controlled by one or more machines, called “nodes”, that run or execute the containerized network elements and are addressable. In this regard, a server cluster may contain at least one master node and a plurality of worker nodes, wherein the master node(s) controls and manages a set of associated worker nodes.

Application 924-1 includes one or more software applications that may be provided to or accessed by user device 910. Application 924-1 may eliminate a need to install and execute the software applications on user device 910. For example, application 924-1 may include software associated with platform 920 and/or any other software capable of being provided via cloud computing environment 922. In some implementations, one application 924-1 may send/receive information to/from one or more other applications 924-1, via virtual machine 924-2.

Virtual machine 924-2 includes a software implementation of a machine (e.g., a computer) that executes programs like a physical machine. Virtual machine 924-2 may be either a system virtual machine or a process virtual machine, depending upon use and degree of correspondence to any real machine by virtual machine 924-2. A system virtual machine may provide a complete system platform that supports execution of a complete operating system (“OS”). A process virtual machine may execute a single program, and may support a single process. In some implementations, virtual machine 924-2 may execute on behalf of a user (e.g., user device 910), and may manage infrastructure of cloud computing environment 922, such as data management, synchronization, or long-duration data transfers.

Virtualized storage 924-3 includes one or more storage systems and/or one or more devices that use virtualization techniques within the storage systems or devices of computing resource 924. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 924-4 may provide hardware virtualization techniques that allow multiple operating systems (e.g., “guest operating systems”) to execute concurrently on a host computer, such as computing resource 924. Hypervisor 924-4 may present a virtual operating platform to the guest operating systems, and may manage the execution of the guest operating systems. Multiple instances of a variety of operating systems may share virtualized hardware resources.

Network 930 may include one or more wired and/or wireless networks. For example, network 930 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 9 are provided as an example. In practice, there may be additional devices and/or networks, fewer devices and/or networks, different devices and/or networks, or differently arranged devices and/or networks than those shown in FIG. 9. Furthermore, two or more devices shown in FIG. 9 may be implemented within a single device, or a single device shown in FIG. 9 may be implemented as multiple, distributed devices. Additionally, or alternatively, a set of devices (e.g., one or more devices) of environment 900 may perform one or more functions described as being performed by another set of devices of environment 900.

### VARIOUS ASPECTS OF EMBODIMENTS

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s) module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

Various further respective aspects and features of embodiments of the present disclosure may be defined by the following items:
Item [1]: An apparatus that may be configured to: obtain upgrade data, wherein the upgrade data may specify an upgrade of a software of a network function; and upgrade the software of the network function using O2 Deployment Management Service based on the obtained upgrade data.
Item [2]: The apparatus according to item [1], wherein the apparatus may be configured to upgrade the software of the network function by: transmitting a first request to create an upgraded instance of the network function with upgrade data to a server; transmitting a second request to route data traffic from an un-upgraded instance of the network function to the upgraded instance of the network function to the server; and transmitting a third request to delete the un-upgraded instance to the server.
Item [3]: The apparatus according to item [2], wherein the upgraded instance of the network function may be created as a Kubernetes deployment object without being exposed to data traffic.
Item [4]: The apparatus according to one of items [2]-[3], wherein the first request, the second request, and the third request may be transmitted using O2 Deployment Management Service.
Item [5]: The apparatus according to one of items [2]-[4], wherein the server may include a Kubernetes API server.
Item [6]: The apparatus according to one of items [1]-[5], wherein the apparatus may be further configured to transmit an upgrade notification to a user, wherein the upgrade notification may be configured to notify the user regarding an outcome of a request to upgrade the software of the network function.
Item [7]: The apparatus according to one of items [1]-[6], wherein the upgrade data may include parameterized Kubernetes native resource manifests.
Item [8]: The apparatus according to one of items [1]-[7], wherein the apparatus may include a Service Management Orchestration (SMO).
Item [9]: A method that may include: obtaining upgrade data, wherein the upgrade data may specify an upgrade of a software of a network function; and upgrading the software of the network function using O2 Deployment Management Service based on the obtained upgrade data.
Item [10]: The method according to item [9], wherein the upgrading the software of the network function may include: transmitting a first request to create an upgraded instance of the network function with upgrade data to a server; transmitting a second request to route data traffic from an un-upgraded instance of the network function to the upgraded instance of the network function to the server; and transmitting a third request to delete the un-upgraded instance to the server.
Item [11]: The method according to item [10], wherein the upgraded instance of the network function may be created as a Kubernetes deployment object without being exposed to data traffic.
Item [12]: The method according to one of items [10]-[11], wherein the first request, the second request, and the third request may be transmitted using O2 Deployment Management Service.
Item [13]: The method according to one of items [10]-[12], wherein the server may include a Kubernetes API server.
Item [14]: The method according to one of items [9]-[13], wherein the method may further include transmitting an upgrade notification to a user, wherein the upgrade notification may be configured to notify the user regarding an outcome of a request to upgrade the software of the network function.
Item [15]: The method according to one of items [9]-[14], wherein the upgrade data may include parameterized Kubernetes native resource manifests.
Item [16]: The method according to one of items [9]-[15], wherein the method may be performed by a Service Management Orchestration (SMO).
Item [17]: A non-transitory computer-readable recording medium that may have recorded thereon instructions executable by an apparatus to cause the apparatus to perform a method including: obtaining upgrade data, wherein the upgrade data may specify an upgrade of a software of a network function; and upgrading the software of the network function using O2 Deployment Management Service based on the obtained upgrade data.
Item [18]: The non-transitory computer-readable recording medium according to item [17], wherein the upgrading the software of the network function may include: transmitting a first request to create an upgraded instance of the network function with upgrade data to a server; transmitting a second request to route data traffic from an un-upgraded instance of the network function to the upgraded instance of the network function to the server; and transmitting a third request to delete the un-upgraded instance to the server.
Item [19]: The non-transitory computer-readable recording medium according to item [18], wherein the upgraded instance of the network function may be created as a Kubernetes deployment object without being exposed to data traffic.
Item [20]: The non-transitory computer-readable recording medium according to one of items [18]-[19], wherein the first request, the second request, and the third request may be transmitted using O2 Deployment Management Service.

It can be understood that numerous modifications and variations of the present disclosure are possible in light of the above teachings. It will be apparent that within the scope of the appended clauses, the present disclosures may be practiced otherwise than as specifically described herein.

What is claimed is:

1. A apparatus configured to:
obtain upgrade data, wherein the upgrade data specifies an upgrade of a software of a network function; and
upgrade the software of the network function using O2 Deployment Management Service based on the obtained upgrade data.

2. The apparatus according to claim 1, wherein the apparatus is configured to upgrade the software of the network function by:
transmitting a first request to create an upgraded instance of the network function with upgrade data to a server;
transmitting a second request to route data traffic from an un-upgraded instance of the network function to the upgraded instance of the network function to the server; and
transmitting a third request to delete the un-upgraded instance to the server.

3. The apparatus according to claim 2, wherein the upgraded instance of the network function is created as a Kubernetes deployment object without being exposed to data traffic.

4. The apparatus according to claim 2, wherein the first request, the second request, and the third request are transmitted using O2 Deployment Management Service.

5. The apparatus according to claim 2, wherein the server comprises a Kubernetes API server.

6. The apparatus according to claim 1, wherein the apparatus is further configured to transmit an upgrade notification to a user, wherein the upgrade notification is configured to notify the user regarding an outcome of a request to upgrade the software of the network function.

7. The apparatus according to claim 1, wherein the upgrade data comprises parameterized Kubernetes native resource manifests.

8. The apparatus according to claim 1, wherein the apparatus comprises a Service Management Orchestration (SMO).

9. A method comprising:
obtaining upgrade data, wherein the upgrade data specifies an upgrade of a software of a network function; and
upgrading the software of the network function using O2 Deployment Management Service based on the obtained upgrade data.

10. The method according to claim 9, wherein the upgrading the software of the network function comprises:
transmitting a first request to create an upgraded instance of the network function with upgrade data to a server,
transmitting a second request to route data traffic from an un-upgraded instance of the network function to the upgraded instance of the network function to the server; and
transmitting a third request to delete the un-upgraded instance to the server.

11. The method according to claim 10, wherein the upgraded instance of the network function is created as a Kubernetes deployment object without being exposed to data traffic.

12. The method according to claim 10, wherein the first request, the second request, and the third request are transmitted using O2 Deployment Management Service.

13. The method according to claim 10, wherein the server comprises a Kubernetes API server.

14. The method according to claim 9, wherein the method further comprises transmitting an upgrade notification to a user, wherein the upgrade notification is configured to notify the user regarding an outcome of a request to upgrade the software of the network function.

15. The method according to claim 9, wherein the upgrade data comprises parameterized Kubernetes native resource manifests.

16. The method according to claim 9, wherein the method is performed by a Service Management Orchestration (SMO).

17. A non-transitory computer-readable recording medium having recorded thereon instructions executable by an apparatus to cause the apparatus to perform a method comprising:
obtaining upgrade data, wherein the upgrade data specifies an upgrade of a software of a network function; and
upgrading the software of the network function using O2 Deployment Management Service based on the obtained upgrade data.

18. The non-transitory computer-readable recording medium according to claim 17, wherein the upgrading the software of the network function comprises:
transmitting a first request to create an upgraded instance of the network function with upgrade data to a server;
transmitting a second request to route data traffic from an un-upgraded instance of the network function to the upgraded instance of the network function to the server; and
transmitting a third request to delete the un-upgraded instance to the server.

19. The non-transitory computer-readable recording medium according to claim 18, wherein the upgraded instance of the network function is created as a Kubernetes deployment object without being exposed to data traffic.

20. The non-transitory computer-readable recording medium according to claim 18, wherein the first request, the second request, and the third request are transmitted using O2 Deployment Management Service.
